(19) United States
(12) Patent Application Publication
(10) Pub. No.: US 2004/0158468 A1
(43) Pub. Date: Aug. 12, 2004

(54) Speech recognition with soft pruning

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/364,528

(22) Filed: Feb. 12, 2003

(51) Int. Cl. G10L 15/00

(52) U.S. Cl. 704/238

(57) ABSTRACT

A method, program product, and system for speech recognition, the method comprising in one embodiment pruning a hypothesis based on a first criteria; storing information about the pruned hypothesis; and reactivating the pruned hypothesis if a second criterion is met. In an embodiment, the first criteria may be that another hypothesis has a better score at that time by some predetermined amount. In an embodiment, the stored information may comprise at least one of a score for the pruned hypothesis, an identification of the hypothesis that caused the pruning and the frame in which the pruning took place. In a further embodiment, the reactivating step may use at least some of the stored information about the pruned hypothesis in performing the reactivation and the second criteria may be that a revised score for the hypothesis that caused the pruning is worse by some predetermined amount from an original expected score calculated for that hypothesis.

### BACKGROUND OF THE INVENTION

Currently, to reduce the amount of computation to a practical amount, large vocabulary speech recognition systems prune hypotheses by rules such as, for example, pruning all hypotheses that have match scores that are worse than a best matching hypothesis by some specified threshold value. If the correct hypothesis is pruned because it temporarily matches worse than the best scoring hypothesis by the specified threshold amount at a given frame in the sentence, the correct hypothesis will never be evaluated further and thus never be chosen as a recognition result.

### SUMMARY OF THE INVENTION

The present invention in one embodiment, is a speech recognition method, comprising: obtaining a first total score comprising a score for a first processed section of input speech data and a continuation score for a first unprocessed section of the input speech data; using the first total score to prune a hypothesis; processing a portion of the first unprocessed section of the input speech data so that a new processed section is obtained having a score comprising the score for the first processed section and a score for the new processed portion of the first unprocessed section; and determining a revised first total score based at least in part on the score for the new processed section; determining if the revised first total score is worse than the first total score by at least a predetermined amount; and if worse, then in some instances reactivating the pruned hypothesis.

In a further embodiment of the present invention, the first total score is for a best hypothesis, and wherein the reactivating step comprises determining if the best hypothesis was used to prune the pruned hypothesis in an earlier frame; if so, then recomputing a pruning threshold; determining if a total score for the pruned hypothesis is better than the recomputed pruning threshold by a predetermined amount; and reactivating the pruned hypothesis only if a difference between the pruning threshold and the total score for the pruned hypothesis exceeds said predetermined amount.

In a further embodiment of the present invention, processing is restarted at the frame where the pruning of the pruned hypothesis occurred.

In a further embodiment of the present invention, the revised total score comprises the score for the new processed section which is the score for the first processed section and the score for the new processed portion of the first unprocessed section and a revised continuation score.

In a further embodiment of the present invention, the revised continuation score is calculated based on the acoustic match score of a phonetic recognizer on the unprocessed section of the input speech data.

In a further embodiment of the present invention, a step is provided of adjusting the estimated total score of a best scoring phoneme sequence relative to a best scoring word sequence.

In a further embodiment of the present invention, the continuation score is computed by a previous pass on the input speech data by a speech recognition process in a multi-pass recognition process.

In a further embodiment of the present invention, the processing for the input speech data is via a priority queue search for a stack decoder.

In a further embodiment of the present invention, the reactivating step comprises inserting the reactivated hypothesis into the priority queue without recalculating a score for the reactivated hypothesis.

In a further embodiment of the present invention, the reactivating step comprises completing an interrupted extension determination before inserting the reactivated hypothesis into the priority queue.

In a further embodiment of the present invention, the continuation-score is determined at least in part by a plurality of frame scores obtained from a forward pass of a first speech recognition process across frames of the input speech data, wherein the score for the first processed section of input speech data is obtained by a backwards pass of a second speech recognition process across frames of the input speech data, and wherein the processing a portion of the first unprocessed section of the input speech data step comprises the backwards pass of the second speech recognition process across the portion of the first unprocessed section of the input speech data, wherein the second speech recognition process is different from the first speech recognition process.

In a further embodiment of the present invention, one of the speech recognition processes uses a simplified grammar search.

In a further embodiment of the present invention, one of the speech recognition processes comprises a reduced vocabulary search.

In a further embodiment of the present invention, the continuation score is determined at least in part by a plurality of frame scores obtained from a first pass of a first speech recognition process across frames of the input speech data, wherein the score for the first processed section of input speech data is obtained by a second pass, in the same direction as the first pass, of a second speech recognition process across frames of the input speech data, and wherein the processing a portion of the first unprocessed section of the input speech data step comprises the second pass of the second speech recognition process across the portion of the first unprocessed section of the input speech data, wherein the second speech recognition process is different from the first speech recognition process.

In a further embodiment of the present invention, the first total score is for a first best hypothesis.

In a further embodiment of the present invention, a step is provided of populating a list with one or more hypotheses that have been pruned, each hypothesis having a score associated therewith, the hypothesis that caused it to be pruned and the frame in which the pruning took place.

In a further embodiment of the present invention, a method is provided for speech recognition, comprising: pruning a hypothesis based on a first criteria; storing information about the pruned hypothesis; and reactivating the pruned hypothesis if a second criterion is met.

In a further embodiment of the present invention, the first criteria is that another hypothesis has a better score at that time by some predetermined amount.

In a further embodiment of the present invention, the information comprises at least one of a score for the pruned hypothesis, an identification of the hypothesis that caused the pruning and the frame in which the pruning took place.

In a further embodiment of the present invention, the reactivating step uses at least some of the stored information about the pruned hypothesis in performing the reactivation.

In a further embodiment of the present invention, the second criteria is that a revised score for the hypothesis that caused the pruning is worse by some predetermined amount from an original expected score calculated for that hypothesis.

In a yet further embodiment of the present invention, a program product is provided for a speech recognition, comprising machine-readable program code for causing, when executed, a machine to perform the following method: obtaining a first total score comprising a score for a first processed section of input speech data and a continuation score for a first unprocessed section of the input speech data; using the first total score to prune a hypothesis; processing a portion of the first unprocessed section of the input speech data so that a new processed section is obtained having a score comprising the score for the first processed section and a score for the new processed portion of the first unprocessed section; and determining a revised first total score based at least in part on the score for the new processed section; determining if the revised first total score is worse than the first total score by at least a predetermined amount; and if worse, then in some instances reactivating the pruned hypothesis.

In a further embodiment of the present invention, a program product is provided for speech recognition, comprising machine-readable program code for causing, when executed, a machine to perform the following method: pruning a hypothesis based on a first criteria; storing information about the pruned hypothesis; and reactivating the pruned hypothesis if a second criterion is met.

In a yet a further embodiment of the present invention, a system is provided for speech recognition, comprising: a component for obtaining a first total score comprising a score for a first processed section of input speech data and a continuation score for a first unprocessed section of the input speech data; a component for using the first total score to prune a hypothesis; a component for processing a portion of the first unprocessed section of the input speech data so that a new processed section is obtained having a score comprising the score for the first processed section and a score for the new processed portion of the first unprocessed section; and a component for determining a revised first total score based at least in part on the score for the new processed section; a component for determining if the revised first total score is worse than the first total score by at least a predetermined amount; and a component for, if it is determined to be worse in the preceding step, then in some instances reactivating the pruned hypothesis.

In a yet further embodiment of the present invention, a system is provided for speech recognition, comprising: a component for pruning a hypothesis based on a first criteria; a component for storing information about the pruned hypothesis; and a component for reactivating the pruned hypothesis if a second criterion is met.

In a yet further embodiment of the present invention, a system is provided for speech recognition, comprising: means for obtaining a first total score comprising a score for a first processed section of input speech data and a continuation score for a first unprocessed section of the input speech data; means for using the first total score to prune a hypothesis; means for processing a portion of the first unprocessed section of the input speech data so that a new processed section is obtained having a score comprising the score for the first processed section and a score for the new processed portion of the first unprocessed section; and means for determining a revised first total score based at least in part on the score for the new processed section; means for determining if the revised first total score is worse than the first total score by at least a predetermined amount; and means for, if it is determined to be worse in the preceding step, then in some instances reactivating the pruned hypothesis.

In a yet further embodiment of the present invention, a system is provided for speech recognition, comprising: means for pruning a hypothesis based on a first criteria; means for storing information about the pruned hypothesis; and means for reactivating the pruned hypothesis if a second criterion is met.

### BRIEF DESCRIPTION OF THE DRAWINGS

FIG. 1 is a flowchart of an embodiment of the present invention.

FIG. 2 is a flowchart of a further embodiment of the present invention.

FIG. 3A and 3B comprises a flowchart of a yet further embodiment of the present invention.

FIG. 4 is a schematic representation of processed and unprocessed sections.

FIG. 5 is a schematic representation of a hypothesis and its prefix hypotheses and a pruned hypothesis.

FIG. 6 is a schematic representation of processed and unprocessed sections in a two pass system.

### DETAILED DESCRIPTION OF THE PREFERRED EMBODIMENTS

### Definitions

The Following Terms may be used in the Description of the Invention and Include New Terms and Terms that are Given Special Meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue.” In a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Best first search” is a search method in which at each step of the search process one or more of the hypotheses from among those with estimated evaluations at or near the best found so far are chosen for further analysis.

“Breadth-first search” is a search method in which at each step of the search process many hypotheses are extended for further evaluation. A strict breadth-first search would always extend all shorter hypotheses before extending any longer hypotheses. In speech recognition whether one hypothesis is “shorter” than another (for determining the order of evaluation in a breadth-first search) is often determined by the estimated ending time of each hypothesis in the acoustic observation sequence. The frame-synchronous beam search is a form of breadth-first search, as is the multi-stack decoder.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Branch and bound search” is a class of search algorithms based on the branch and bound algorithm. In the branch and bound algorithm the hypotheses are organized as a tree. For each branch at each branch point, a bound is computed for the best score on the subtree of paths that use that branch. That bound is compared with a best score that has already been found for some path not in the subtree from that branch. If the other path is already better than the bound for the subtree, then the subtree may be dropped from further consideration. A branch and bound algorithm may be used to do an admissible A* search. More generally, a branch and bound type algorithm might use an approximate bound rather than a guaranteed bound, in which case the branch and bound algorithm would not be admissible. In fact for practical reasons, it is usually necessary to use a non-admissible bound just as it is usually necessary to do beam pruning. One implementation of a branch and bound search of the tree of possible sentences uses a priority queue and thus is equivalent to a type of stack decoder, using the bounds as look-ahead scores.

“Admissible A* search.” The term A* search is used not just in speech recognition but also to searches in a broader range of tasks in artificial intelligence and computer science. The A* search algorithm is a form of best first search that generally includes a look-ahead term that is either an estimate or a bound on the score portion of the data that has not yet been scored. Thus the A* algorithm is a form of priority queue search. If the look-ahead term is a rigorous bound (making the procedure “admissible”), then once the A* algorithm has found a complete path, it is guaranteed to be the best path. Thus an admissible A* algorithm is an instance of the branch and bound algorithm.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is grouping of speech elements, which may or may not be in sequence. However, in many speech recognition implementations, the hypothesis will be a sequence or a combination of sequences of speech elements. Corresponding to any hypothesis is a set of models, which may, as noted above in some embodiments, be a sequence of models that represent the speech elements. Thus, a match score for any hypothesis against a given set of acoustic observations, in some embodiments, is actually a match score for the concatenation of the set of models for the speech elements in the hypothesis.

“Set of hypotheses” is a collection of hypotheses that may have additional information or structural organization supplied by a recognition system. For example, a priority queue is a set of hypotheses that has been rank ordered by some priority criterion; an n-best list is a set of hypotheses that has been selected by a recognition system as the best matching hypotheses that the system was able to find in its search. A hypothesis lattice or speech element lattice is a compact network representation of a set of hypotheses comprising the best hypotheses found by the recognition process in which each path through the lattice represents a selected hypothesis.

“Selected set of hypotheses” is the set of hypotheses returned by a recognition system as the best matching hypotheses that have been found by the recognition search process. The selected set of hypotheses may be represented, for example, explicitly as an n-best list or implicitly as the set of paths through a lattice. In some cases a recognition system may select only a single hypothesis, in which case the selected set is a one element set. Generally, the hypotheses in the selected set of hypotheses will be complete sentence hypotheses; that is, the speech elements in each hypothesis will have been matched against the acoustic observations corresponding to the entire sentence. In some implementations, however, a recognition system may present a selected set of hypotheses to a user or to an application or analysis program before the recognition process is completed, in which case the selected set of hypotheses may also include partial sentence hypotheses. Such an implementation may be used, for example, when the system is getting feedback from the user or program to help complete the recognition process.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Missing piece evaluation” is an estimate of the match score that the best continuation of a particular hypothesis is expected to achieve on an interval of acoustic observations that was yet not matched in the interval of acoustic observations that have been matched against the hypothesis itself. For admissible A* algorithms or branch and bound algorithms, a bound on the best possible score on the unmatched interval may be used rather than an estimate of the expected score.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far.” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Grammar state” is a representation of the fact that, for purposes of determining which sequences of linguistic elements form a grammatical sentence, certain sets of sentence-initial sequences may all be considered equivalent. In a finite-state grammar, each grammar state represents a set of sentence-initial sequences of linguistic elements. The set of sequences of linguistic elements associated with a given state is the set of sequences that, starting from the beginning of the sentence, lead to the given state. The states in a finite-state grammar may also be represented as the nodes in a directed graph or network, with a linguistic element as the label on each arc of the graph. The set of sequences of linguistic elements of a given state correspond to the sequences of linguistic element labels on the arcs in the set of paths that lead to the node that corresponds to the given state. For purposes of determining what continuation sequences are grammatical under the given grammar, all sequences that lead to the same state are treated as equivalent. All that matters about a sentence-initial sequence of linguistic elements (or a path in the directed graph) is what state (or node) it leads to. Generally, speech recognition systems use a finite state grammar, or a finite (though possibly very large) statistical language model. However, some embodiments may use a more complex grammar such as a context-free grammar, which would correspond to a denumerable, but infinite number of states. In some embodiments for context-free grammars, non-terminal symbols play a role similar to states in a finite-state grammar, but the associated sequence of linguistic elements for a non-terminal symbol will be for some span of linguistic elements that may be in the middle of the sentence rather than necessarily starting at the beginning of the sentence. Any finite-state grammar may alternately be represented as a context-free grammar.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a nonzero probability.

“Entropy” is an information theoretic measure of the amount of information in a probability distribution or the associated random variables. It is generally given by the formula E=Σᵢ pᵢ log(pᵢ), where the logarithm is taken base 2 and the entropy is measured in bits.

“Perplexity” is a measure of the degree of branchiness of a grammar or language model, including the effect of non-uniform probability distributions. In some embodiments it is 2 raised to the power of the entropy. It is measured in units of active vocabulary size and in a simple grammar in which every word is legal in all contexts and the words are equally likely, the perplexity will equal the vocabulary size. When the size of the active vocabulary varies, the perplexity is like a geometric mean rather than an arithmetic mean.

“Decision Tree Question” in a decision tree, is a partition of the set of possible input data to be classified. A binary question partitions the input data into a set and its complement. In a binary decision tree, each node is associated with a binary question.

“Classification Task” in a classification system is a partition of a set of target classes.

“Hash function” is a function that maps a set of objects into the range of integers {0, 1, . . . , N−1}. A hash function in some embodiments is designed to distribute the objects uniformly and apparently randomly across the designated range of integers. The set of objects is often the set of strings or sequences in a given alphabet.

“Lexical retrieval and prefiltering.” Lexical retrieval is a process of computing an estimate of which words, or other speech elements, in a vocabulary or list of such elements are likely to match the observations in a speech interval starting at a particular time. Lexical prefiltering comprises using the estimates from lexical retrieval to select a relatively small subset of the vocabulary as candidates for further analysis. Retrieval and prefiltering may also be applied to a set of sequences of speech elements, such as a set of phrases. Because it may be used as a fast means to evaluate and eliminate most of a large list of words, lexical retrieval and prefiltering is sometimes called “fast match” or “rapid match.”

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The present invention replaces the pruning of a conventional speech recognition system with a form of “soft pruning.” In this regard, a decision to prune a hypothesis is made to be a temporary decision that can later be reversed.

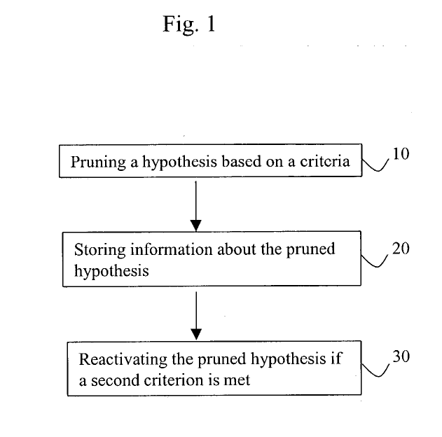

Referring to FIG. 1, a first embodiment of the present invention is shown. In block 10 a hypothesis is pruned based on a first criteria. In one implementation of this step, the first criteria may be that another hypothesis has a better score by some predetermined amount at that time.

Referring to block 20, a step is performed of storing information about the pruned hypothesis. For example, the information could comprise a score for the pruned hypothesis, an identification of the hypothesis that caused the pruning and the frame in which the pruning took place.

Referring to block 30, a step is then performed of reactivating the pruned hypothesis if a second criterion is met. By way of example, the second criteria may be that a revised score for the hypothesis that caused the pruning is worse by some predetermined amount from the original expected score calculated for that hypothesis.

In a second embodiment of the invention, reactivation of pruned hypotheses is based on the use of a total score and revisions to that total score. In this regard, a match score for each hypothesis is called a total score and is provided in two parts: a match score for acoustic frames that have been matched up to the current frame, and an estimate of a match score that the best continuation for the hypothesis will achieve for a designated interval of speech, which may be the rest of the sentence. A section of a speech interval that has been initially matched against a given hypothesis is called a processed section. The remaining portion of the larger speech interval is called the unprocessed section. The estimate of the total score for the given hypothesis on the larger interval can be regarded as the combination of the actual match score that has been computed for the given hypothesis on the processed section combined with a continuation score that estimates how well the best continuation of the given hypothesis will score on the presently unprocessed section. Accordingly, a first total score may be generated after a certain number of frames for the hypothesis have been processed. Then a revised total score for a best matching hypothesis after new frames have been processed is generated. When this revised total score is worse by a predetermined amount than the first total score generated for that hypothesis using its earlier predicted continuation score, it shows that other hypotheses may have been falsely pruned by comparison with the hypothesis that had been overrated, so hypotheses that have been temporarily pruned are or may be reactivated.

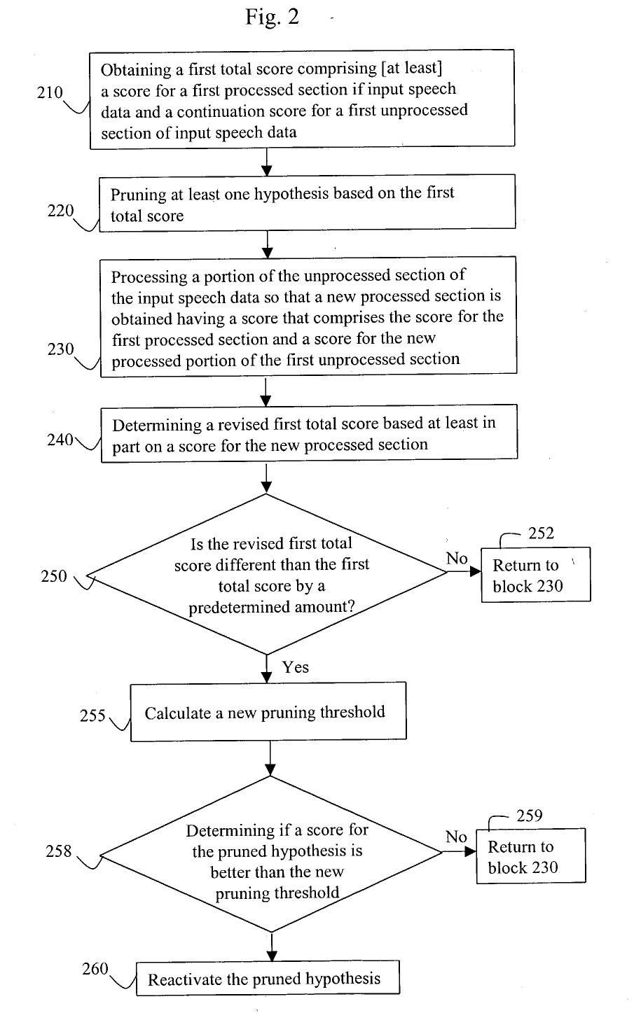

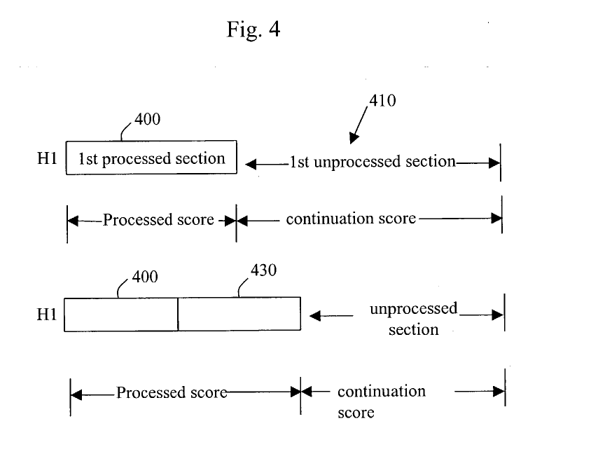

Referring now to FIG. 2, the second embodiment of the speech recognition,method, program product and system of the present invention is illustrated. Referring to block 210, a first total score is obtained comprising a score for a first processed section of input speech data and a continuation score for a first unprocessed section of the input speech data. Note that the continuation score for the total score can be an accumulation of frame scores or other scores to any point in the future and is not restricted to the end of a sentence. FIG. 4 illustrates the concept of a first processed section 400 and a first unprocessed section 410.

The continuation score may be obtained in a variety of ways, including via an earlier pass by a preliminary speech recognition process that may be different from the later regular speech recognition process that uses the soft pruning. For example, the preliminary speech recognition on the unprocessed portion of speech may use standard speech recognition matching techniques. In one example implementation, this preliminary speech recognition uses a smaller grammar or language model than the main speech recognition process. There may be a mapping such that each state in the larger grammar is mapped into a state in the smaller grammar. If a stochastic grammar or statistical language model is used in the regular recognition match score, the preferred embodiment of the preliminary recognition will use a conservative estimate, that is, it may make the estimate of the language model score of the continuation at least as good as the actual continuation. To make a conservative estimate, an embodiment may use pseudo-probabilities, that is, it may use scores corresponding to conditional probabilities that add to more than one.

In another embodiment, the preliminary recognition process may be performed forward in time and the regular recognition process, with soft pruning, is then performed backwards in time. This two-pass forward-backward recognition process allows the preliminary recognition to be substantially complete by the time the regular recognition is started in the backward direction. In yet another embodiment, both the preliminary and the regular recognition are performed forwards in time, but the regular recognition process is delayed so that the preliminary recognition can be completed on some speech portion that is unprocessed relative to a given hypothesis in the regular recognition process.

In the embodiments described above, the preliminary recognition will have computed for each state in the smaller grammar the score of the best path starting from that grammar state and matching the portion of speech that has been unprocessed for the given hypothesis in the regular recognition process. The given hypothesis ends in some state in the larger grammar. The estimated continuation score for the given hypothesis in the embodiment then is just the score of the state in the small grammar to which the hypothesis ending state in the large grammar is mapped in the grammar mapping.

As a further alternative, the continuation score may be estimated based on a detection of a recognized subset of phonemes in the unprocessed section 410. Such a recognized set of phonemes might comprise, for example, a detection of distinctive sounds such as r's or s's in the unprocessed section 410. As a further alternative, a phonemic of phonetic recognition may be done recognizing the entire set of phonemes or phonetic symbols. If a subset or the entire set of phonemes has been recognized, the continuation score may be estimated by comparing the actual number of detections of each phoneme with the expected number of occurrences for a continuation of the given hypothesis.

Referring to block 220, the first total score for a best scoring hypothesis H in the regular speech recognition process is used to prune another hypothesis. By way of example, a pruning threshold can be determined by subtracting a predetermined pruning margin from the first total score for the hypothesis H. The total scores for other active hypotheses may then be compared to this pruning threshold for this frame and hypotheses with total scores below the pruning threshold are pruned. In some embodiments, multiple hypotheses may be pruned. For purposes of explication, assume that a hypothesis G has been pruned. A step is then performed in one embodiment of the invention of retaining information about which hypothesis or hypotheses have been pruned along with their respective associated scores, the hypothesis that caused it to be pruned and the frame in which the pruning took place. In one embodiment of the invention, the information identifying which hypotheses have been pruned is stored in a list, with each hypothesis in the list having associated therewith a score, the hypothesis that caused it to be pruned and the frame in which the pruning took place.

Referring to block 230, a portion of the unprocessed section of the input speech data is processed with a speech recognition process so that a new processed section is obtained having a score comprising the score for the first processed section 400 and a score for the new processed portion 230 of the first unprocessed section.

Referring to block 240, a revised first total score for the hypothesis H is determined based at least in part on the score for the new processed section. In one embodiment, the revised total score will include a revised continuation score along with the score for the new processed section. For example, the revised continuation score could be determined by the same process that was used to determine the original continuation score, but restricted to the now reduced portion 440 of unprocessed speech.

Referring to block 250, a determination is made whether the revised total score for the hypothesis H from block 240 is worse than the first total score for Hypothesis H by at least a predetermined amount. If it is not, then the execution returns to block 230, per block 252.

Referring to block 255, if the revised first total score is worse than the first total score by at least the predetermined amount, then a new pruning threshold is calculated. In block 258 a determination is made whether the stored match score of the hypothesis G that was pruned is better than the new pruning threshold. If it is not, then the execution returns to block 230, per block 259. The new pruning threshold may be determined either by the newly revised total score for hypothesis H, or by another hypothesis that has a score better than the revised score for H.

Referring to block 260, if the score of the hypothesis G is better than the new pruning threshold, reactivate G and insert G into the priority queue. In one embodiment, this reactivation step would comprise accessing the list of hypothesis pruned by H and reactivating all pruned hypotheses with scores better than the new pruning threshold.

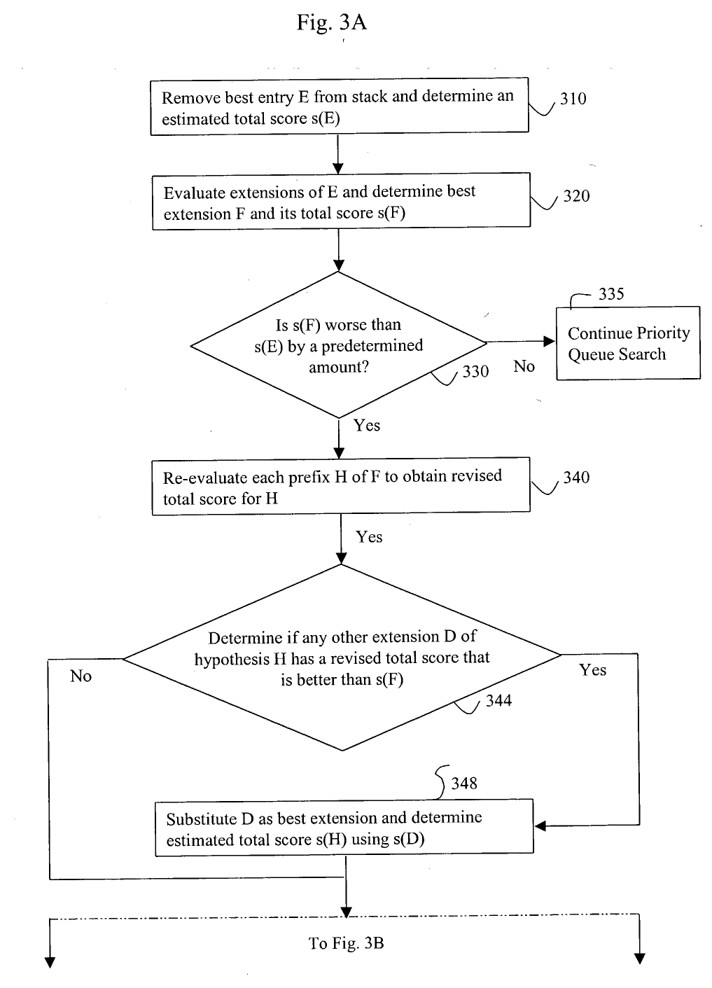

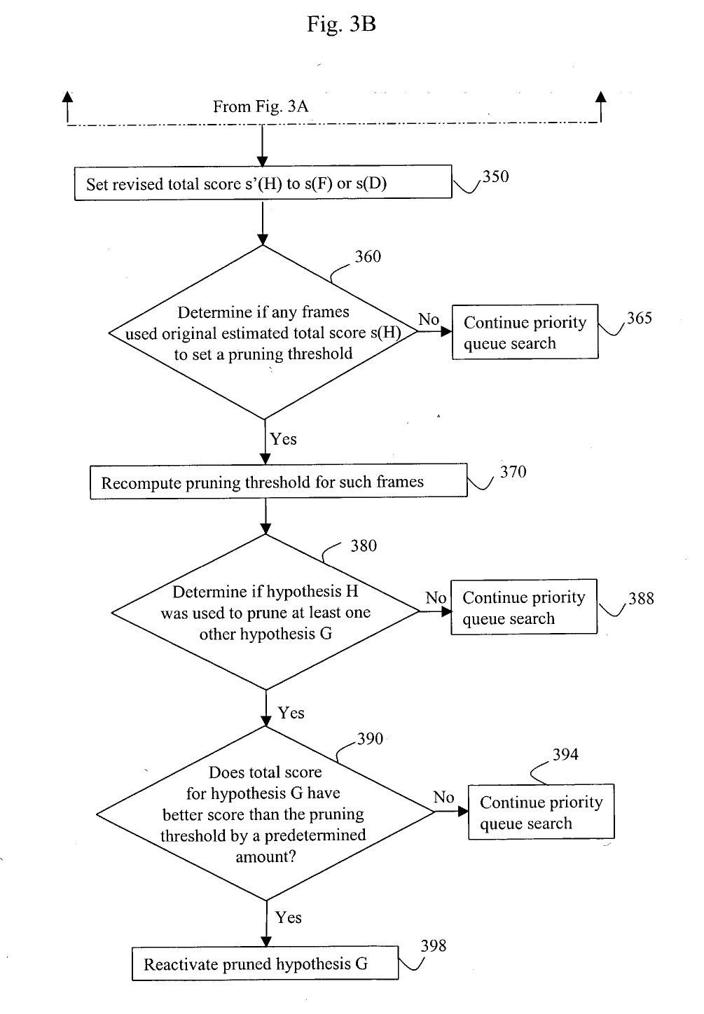

In a further embodiment, block 230 and block 240 of FIG. 1 are implemented by augmenting a priority queue search to keep track of revised total scores as illustrated in FIGS. 3A and 3B.

Referring to block 310, a best hypothesis entry E (from the beginning of the sentence) is removed from a stack to have its extensions evaluated, as in a standard priority queue search and an estimated total score s(E) is determined.

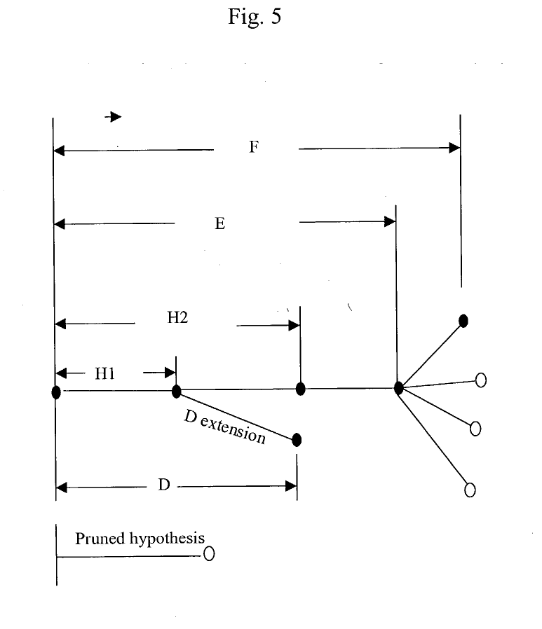

Referring to block 320, each of the extensions of hypothesis E is evaluated and put back in the queue. As known to those skilled in the art of priority queue search, the extensions to be evaluated may first be prefiltered to select only the most promising extensions. Each extension is evaluated by its estimated total score. The best extension of hypothesis E is determined to create a new hypothesis F, and its estimated total score s(F) is recorded. FIG. 5 illustrates an example of the hypotheses H1, H2, E, F, and D.

Referring to block 330, a determination is made whether the total score s(F) estimated for hypothesis F is worse than the total score s(E) for hypothesis E previously estimated by more than some predetermined amount. The predetermined amount may be zero, or may be some non-zero amount designed to prevent doing the reactivation computation for a small change in the estimated total score. If it is not, then the priority queue search is continued, per block 335.

Referring to block 340, if the total score s(F) is worse than s(E) by the predetermined amount, then each prefix hypothesis H of F is re-evaluated. A prefix of F is any initial subsequence of the sequence of speech elements in the hypothesis F. For example, in FIG. 5, the prefixes for hypothesis F are Hypotheses H1, H2, and E. The prefixes of F may, in one embodiment, be re-evaluated in reverse order, working backwards from E to each shorter prefix, i.e., evaluating E, then H1, then H2. The acoustic match score for each prefix hypothesis will not have changed, only the estimated score for the previously unprocessed portion 230 will have changed, so the re-evaluation comprises obtaining the revised estimate for the best continuation of the hypothesis. For example, the revised total score estimated for hypothesis E is S(F), because F was selected as the best extension of hypothesis E.

Referring to block 344, for other prefix hypotheses H, the priority queue would also be checked to see if there is any other extension D of H with estimated total score s(D) that is better than s(F). If there is a better scoring extension D, then in block 348 the revised estimated total score s′(H) for the hypothesis H is determined to be the score s(D) for the best such extension D.

Referring now to block 350, the revised total score s′(H) is set to s(D) if that is the best score, otherwise, the new total score is retained as s(F).

Referring to block 360, it is determined if there are any frames for which the old estimated total score s(H) for the various prefix hypotheses of F is the best score of record for that frame (and thus used to set the pruning threshold for that frame). If the answer is YES, then in block 370 the pruning threshold is recomputed for such frames. The new pruning threshold for a given frame may be recomputed using the revised total score s′(H) or the estimated total score for the hypothesis that had previously been the second best recorded for the given frame, if any, depending on which of these two scores is better.

Referring now to block 380, a determination is made whether prefix hypothesis H was previously used to prune at least one other hypothesis G. If the answer is NO, then in block 384 processing continues for the priority queue search.

Referring to block 390, it is determined if the revised total score for hypothesis G has a better score than the recomputed pruning threshold for that frame by a predetermined amount. If the answer is NO, then the priority search is continued in block 394.

Referring to block 398, if the answer is YES, then the pruned hypothesis G is reactivated.

To reactivate the pruned hypothesis, in one embodiment, it is simply put back in the priority queue at the priority level based on its estimated total score. In this preferred embodiment, the priority queue will contain both normal hypotheses and re-activated pruned hypotheses. If a hypothesis was previously pruned due to node level pruning before completion of its evaluation to the end of the extension that was made from its predecessor, then when that hypothesis is re-activated and then later chosen for extension, the extension in this preferred embodiment will comprise completing the extension evaluation for the reactivated hypothesis that was previously interrupted by pruning. This extension evaluation in one embodiment could be restarted at the frame at which the hypothesis had been pruned only after the reactivated hypothesis has become high enough in the stack to require the computation of extensions. In a second embodiment, the completion of the interrupted extension evaluation for the reactivated hypothesis would be performed at the time that the hypothesis is re-activated, and then the hypothesis is entered into the priority queue as a normal hypothesis.

Thus, although the present invention may be used in the context of a two-pass recognition system, it can also be used to lower the error rate in any priority queue decoder. Also note that any time that a soft pruned hypothesis is reactivated, that hypothesis also would have been pruned by a frame synchronous beam search with the same pruning margin. Thus a priority queue search with soft pruning will have a lower error rate than either kind of conventional search. Because the invention does not depend on being part of a two-pass recognition system, the use of a phoneme recognizer may be utilized in some embodiments, rather than a full separate recognition pass.

Referring again to the continuation scores, a variety of methods can be used to estimate the continuation score of a hypothesis H. In fact, any method for estimating look-ahead scores for a priority queue decoder may be used, as long as the look-ahead estimate covers the full designated section (to whatever frame that may be) of unprocessed speech 410.

In one embodiment, for example, the continuation score could be based on a phoneme recognizer that has been run on the section 410. In this preferred embodiment, the continuation score would be based on the score of the best scoring phoneme sequence for the interval of speech in section 410. Because not all phoneme sequences form legal word sequences, the best scoring phoneme sequence may score somewhat better than an acoustic match score for the best scoring legal word sequence. Thus, in one embodiment, the score for the best scoring word sequence for speech section 410 may be adjusted, for example, by subtracting the estimated amount by which the best scoring phoneme sequence scores better on average than the best scoring word sequence. The amount of this adjustment can be estimated by measuring the amount by which such scores of best scoring phoneme sequences exceed the scores of the best scoring word sequences in acoustic training data. In the preferred embodiment, this adjustment amount is estimated on known training data as an average score difference per frame. The adjustment for the section 210 would then be this average amount times the number of frames in section 410.

In a further embodiment, a priority queue search with soft pruning may be used as the second (or later) pass of a multi-pass recognition system. For example, it could be the backward pass in a two pass system with a forward pass and a backward pass. A multiple pass recognition system might be preferred, for example, because more sophisticated, but computationally expensive, models could be used in later passes because the number of hypotheses would already have been reduced by the analyses in the earlier passes.

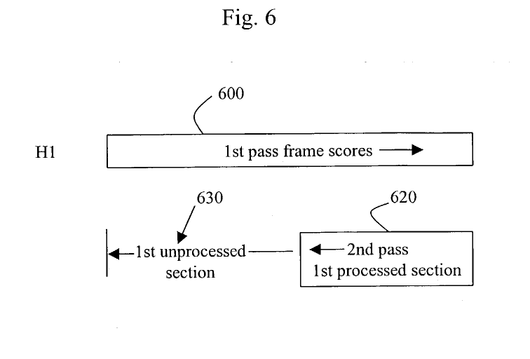

In a real-time two pass system with a backward pass as the second pass, it is preferred in some embodiments for the backward pass to be as fast as possible while maintaining accuracy. The look-ahead or continuation score information for the backward second pass would extend all the way to the beginning of the sentence. That is, the continuation would include the whole sentence because the pass that we are considering is the second or backward pass. In this embodiment the forward pass used to determine the continuation score could be a full speech recognition process, limited only by the requirement of using models simple enough so that the computation can be performed near real-time while the utterance is being spoken. FIG. 6 illustrates a forward pass 600 as a first pass in the embodiment. The second backward pass is shown to include a first processed section 620 and a first unprocessed section 630 for which a continuation score will be determined using selected frame scores from the first pass 600.

In one such embodiment, the forward (first) pass recognition process could be a full recognition, but with a simplified or collapsed grammar and vocabulary. In this embodiment, there is a mapping from grammar states in the full grammar to grammar states in the collapsed grammar used in the first pass. The first pass recognition would then compute the score for the best scoring path in the collapsed grammar which arrives at any given grammar node at any given frame. To get the continuation score for any hypothesis H in the second, backward pass, this embodiment looks up the score for the grammar node which corresponds to the ending node of H. It looks up the score for that grammar node at the frame that is the estimated ending time of H (which is the beginning of the unprocessed section 610). Note that since the second pass is going backwards, the unprocessed section 610 is actually the beginning section of the sentence, so that the first pass has already computed a score for the best path to each grammar node (except for grammar nodes that are pruned or not activated, which receive a default score equivalent to the pruning threshold). The continuation score for the hypothesis H for its unprocessed section 630 is then just the score that the first pass has computed for the best path moving in the direction of the first pass that gets to the grammar node in the collapsed grammar that corresponds to the grammar node for the end of hypothesis H.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A speech recognition method, comprising:
obtaining a first total score comprising a score for a first processed section of input speech data and a continuation score for a first unprocessed section of the input speech data;
using the first total score to prune a hypothesis;
processing a portion of the first unprocessed section of the input speech data so that a new processed section is obtained having a score comprising the score for the first processed section and a score for the new processed portion of the first unprocessed section; and
determining a revised first total score based at least in part on the score for the new processed section;
determining if the revised first total score is worse than the first total score by at least a predetermined amount; and
if worse, then in some instances reactivating the pruned hypothesis.

2. The method as defined in claim 1, wherein the first total score is for a best hypothesis, and wherein the reactivating step comprises
determining if the best hypothesis was used to prune the pruned hypothesis in an earlier frame;
if so, then recomputing a pruning threshold;
determining if a total score for the pruned hypothesis is better than the recomputed pruning threshold by a predetermined amount; and
reactivating the pruned hypothesis only if a difference between the pruning threshold and the total score for the pruned hypothesis exceeds said predetermined amount.

3. The method as defined in claim 2, wherein processing is restarted at the frame where the pruning of the pruned hypothesis occurred.

4. The method as defined in claim 1, wherein the revised total score comprises the score for the new processed section which is the score for the first processed section and the score for the new processed portion of the first unprocessed section and a revised continuation score.

5. The method as defined in claim 4, wherein the revised continuation score is calculated based on the acoustic match score of a phonetic recognizer on the unprocessed section of the input speech data.

6. The method as defined in claim 5, further comprising adjusting the estimated total score of a best scoring phoneme sequence relative to a best scoring word sequence.

7. The method as defined in claim 4, wherein the continuation score is computed by a previous pass on the input speech data by a speech recognition process in a multi-pass recognition process.

8. The method as defined in claim 1, wherein the processing for the input speech data is via a priority queue search for a stack decoder.

9. The method as defined in claim 8, wherein said reactivating step comprises inserting the reactivated hypothesis into the priority queue without recalculating a score for the reactivated hypothesis.

10. The method as defined in claim 8, wherein the reactivating step comprises completing an interrupted extension determination before inserting the reactivated hypothesis into the priority queue.

11. The method as defined in claim 4, wherein the continuation score is determined at least in part by a plurality of frame scores obtained from a forward pass of a first speech recognition process across frames of the input speech data, wherein the score for the first processed section of input speech data is obtained by a backwards pass of a second speech recognition process across frames of the input speech data, and wherein the processing a portion of the first unprocessed section of the input speech data step comprises the backwards pass of the second speech recognition process across the portion of the first unprocessed section of the input speech data, wherein the second speech recognition process is different from the first speech recognition process.

12. The method as defined in claim 11, wherein one of the speech recognition processes uses a simplified grammar search.

13. The method as define in claim 11, wherein one of the speech recognition processes comprises a reduced vocabulary search.

14. The method as defined in claim 4,
wherein the continuation score is determined at least in part by a plurality of frame scores obtained from a first pass of a first speech recognition process across frames of the input speech data,
wherein the score for the first processed section of input speech data is obtained by a second pass, in the same direction as the first pass, of a second speech recognition process across frames of the input speech data, and wherein the processing a portion of the first unprocessed section of the input speech data step comprises the second pass of the second speech recognition process across the portion of the first unprocessed section of the input speech data, wherein the second speech recognition process is different from the first speech recognition process.

15. The method as defined in claim 14, wherein one of the speech recognition processes uses a simplified grammar search.

16. The method as define in claim 14, wherein one of the speech recognition processes comprises a reduced vocabulary search.

17. The method as defined in claim 1, wherein the first total score is for a first best hypothesis.

18. The method as defined in claim 1, further comprising populating a list with one or more hypotheses that have been pruned, each hypothesis having a score associated therewith, the hypothesis that caused it to be pruned and the frame in which the pruning took place.

19. A method for speech recognition, comprising:
pruning a hypothesis based on a first criteria;
storing information about the pruned hypothesis; and
reactivating the pruned hypothesis if a second criterion is met.

20. The method as defined in claim 19, wherein the first criteria is that another hypothesis has a better score at that time by some predetermined amount.

21. The method as defined in claim 19, wherein the information comprises at least one of a score for the pruned hypothesis, an identification of the hypothesis that caused the pruning and the frame in which the pruning took place.

22. The method as defined in claim 21, wherein the reactivating step uses at least some of the stored information about the pruned hypothesis in performing the reactivation.

23. The method as defined in claim 19, wherein the second criteria is that a revised score for the hypothesis that caused the pruning is worse by some predetermined amount from an original expected score calculated for that hypothesis.

24. A program product for a speech recognition method, comprising machine-readable program code for causing, when executed, a machine to perform the following method:
obtaining a first total score comprising a score for a first processed section of input speech data and a continuation score for a first unprocessed section of the input speech data;
using the first total score to prune a hypothesis;
processing a portion of the first unprocessed section of the input speech data so that a new processed section is obtained having a score comprising the score for the first processed section and a score for the new processed portion of the first unprocessed section; and
determining a revised first total score based at least in part on the score for the new processed section;
determining if the revised first total score is worse than the first total score by at least a predetermined amount; and
if worse, then in some instances reactivating the pruned hypothesis.

25. The program product as defined in claim 24, wherein the first total score is for a best hypothesis, and wherein the reactivating step comprises
determining if the best hypothesis was used to prune the pruned hypothesis in an earlier frame;
if so, then recomputing a pruning threshold;
determining if a total score for the pruned hypothesis is better than the recomputed pruning threshold by a predetermined amount; and
reactivating the pruned hypothesis only if a difference between the pruning threshold and the total score for the pruned hypothesis exceeds said predetermined amount.

26. The program product as defined in claim 25, wherein processing is restarted at the frame where the pruning of the pruned hypothesis occurred.

27. The program product as defined in claim 24, wherein the revised total score comprises the score for the new processed section which is the score for the first processed section and the score for the new processed portion of the first unprocessed section and a revised continuation score.

28. The method as defined in claim 27, wherein the revised continuation score is calculated based on the acoustic match score of a phonetic recognizer on the unprocessed section of the input speech data.

29. The program product as defined in claim 28, further comprising code for adjusting the estimated total score of a best scoring phoneme sequence relative to a best scoring word sequence.

30. The program product as defined in claim 27, wherein the continuation score is computed by a previous pass on the input speech data by a speech recognition process in a multi-pass recognition process.

31. The program product as defined in claim 24, wherein the processing for the input speech data is via a priority queue search for a stack decoder.

32. The program product as defined in claim 31, wherein said reactivating step comprises inserting the reactivated hypothesis into the priority queue without recalculating a score for the reactivated hypothesis.

33. The program product as defined in claim 31, wherein the reactivating step comprises completing an interrupted extension determination before inserting the reactivated hypothesis into the priority queue.

34. The program product as defined in claim 27, wherein the continuation score is determined at least in part by a plurality of frame scores obtained from a forward pass of a first speech recognition process across frames of the input speech data, wherein the score for the first processed section of input speech data is obtained by a backwards pass of a second speech recognition process across frames of the input speech data, and wherein the processing a portion of the first unprocessed section of the input speech data step comprises the backwards pass of the second speech recognition process across the portion of the first unprocessed section of the input speech data, wherein the second speech recognition process is different from the first speech recognition process.

35. The program product as defined in claim 34, wherein one of the speech recognition processes uses a simplified grammar search.

36. The program product as define in claim 34, wherein one of the speech recognition processes comprises a reduced vocabulary search.

37. The program product as defined in claim 27,
wherein the continuation score is determined at least in part by a plurality of frame scores obtained from a first pass of a first speech recognition process across frames of the input speech data,
wherein the score for the first processed section of input speech data is obtained by a second pass, in the same direction as the first pass, of a second speech recognition process across frames of the input speech data, and wherein the processing a portion of the first unprocessed section of the input speech data step comprises the second pass of the second speech recognition process across the portion of the first unprocessed section of the input speech data, wherein the second speech recognition process is different from the first speech recognition process.

38. The program product as defined in claim 37, wherein one of the speech recognition processes uses a simplified grammar search.

39. The program product as define in claim 37, wherein one of the speech recognition processes comprises a reduced vocabulary search.

40. The program product as defined in claim 24, wherein the first total score is for a first best hypothesis.

41. The program product as defined in claim 24, further comprising program code for populating a list with one or more hypotheses that have been pruned, each hypothesis having a score associated therewith, the hypothesis that caused it to be pruned and the frame in which the pruning took place.

42. A program product for speech recognition, comprising machine-readable program code for causing, when executed, a machine to perform the following method:
pruning a hypothesis based on a first criteria;
storing information about the pruned hypothesis; and
reactivating the pruned hypothesis if a second criterion is met.

43. The program product as defined in claim 42, wherein the first criteria is that another hypothesis has a better score at that time by some predetermined amount.

44. The program product as defined in claim 42, wherein the information comprises at least one of a score for the pruned hypothesis, an identification of the hypothesis that caused the pruning and the frame in which the pruning took place.

45. The program product as defined in claim 44, wherein the reactivating step uses at least some of the stored information about the pruned hypothesis in performing the reactivation.

46. The program product as defined in claim 42, wherein the second criteria is that a revised score for the hypothesis that caused the pruning is worse by some predetermined amount from an original expected score calculated for that hypothesis.

47. A system for speech recognition, comprising:
a component for obtaining a first total score comprising a score for a first processed section of input speech data and a continuation score for a first unprocessed section of the input speech data;
a component for using the first total score to prune a hypothesis;
a component for processing a portion of the first unprocessed section of the input speech data so that a new processed section is obtained having a score comprising the score for the first processed section and a score for the new processed portion of the first unprocessed section; and
a component for determining a revised first total score based at least in part on the score for the new processed section;
a component for determining if the revised first total score is worse than the first total score by at least a predetermined amount; and a component for, if it is determined to be worse in the preceding step, then in some instances reactivating the pruned hypothesis.

48. The system as defined in claim 47, wherein the first total score is for a best hypothesis, and wherein the reactivating component comprises
a component for determining if the best hypothesis was used to prune the pruned hypothesis in an earlier frame;
a component for, if the best hypothesis was used to prune in the earlier frame, then recomputing a pruning threshold;
a component for determining if a total score for the pruned hypothesis is better than the recomputed pruning threshold by a predetermined amount; and
a component for reactivating the pruned hypothesis only if a difference between the pruning threshold and the total score for the pruned hypothesis exceeds said predetermined amount.

49. The system as defined in claim 47, further comprising a component for populating a list with one or more hypotheses that have been pruned, each hypothesis having a score associated therewith, the hypothesis that caused it to be pruned and the frame in which the pruning took place.

50. A system for speech recognition, comprising:
a component for pruning a hypothesis based on a first criteria;
a component for storing information about the pruned hypothesis; and
a component for reactivating the pruned hypothesis if a second criterion is met.

51. The system as defined in claim 50, wherein the first criteria is that another hypothesis has a better score at that time by some predetermined amount.

52. The system as defined in claim 50, wherein the information comprises at least one of a score for the pruned hypothesis, an identification of the hypothesis that caused the pruning and the frame in which the pruning took place.

53. The system as defined in claim 52, wherein the reactivating component uses at least some of the stored information about the pruned hypothesis in performing the reactivation.

54. The system as defined in claim 50, wherein the second criteria is that a revised score for the hypothesis that caused the pruning is worse by some predetermined amount from an original expected score calculated for that hypothesis.

55. A system for speech recognition, comprising:
means for obtaining a first total score comprising a score for a first processed section of input speech data and a continuation score for a first unprocessed section of the input speech data;
means for using the first total score to prune a hypothesis;
means for processing a portion of the first unprocessed section of the input speech data so that a new processed section is obtained having a score comprising the score for the first processed section and a score for the new processed portion of the first unprocessed section; and
means for determining a revised first total score based at least in part on the score for the new processed section;
means for determining if the revised first total score is worse than the first total score by at least a predetermined amount; and
means for, if it is determined to be worse in the preceding step, then in some instances reactivating the pruned hypothesis.

56. A system for speech recognition, comprising:
means for pruning a hypothesis based on a first criteria;
means for storing information about the pruned hypothesis; and
means for reactivating the pruned hypothesis if a second criterion is met.
